(19) United States
(12) Patent Application Publication
(10) Pub. No.: US 2009/0089112 A1
(43) Pub. Date: Apr. 2, 2009

(54) Service Resource Evaluation Method and System

(75) Inventors: Paul Lawrence Mullen, Waukesha, WI (US); Richard Lee Frowein, Waukesha, WI (US); Crispian Lee Sievenpiper, Waukesha, WI (US); Adrian Francis Warner, Delefield, WI (US)

Correspondence Address: GE HEALTHCARE;c/o FLETCHER YODER, PC, P.O. BOX 692289, HOUSTON, TX, 77269-2289, US

(73) Assignee: GENERAL ELECTRIC COMPANY, Schenectady, NY (US)

(21) Appl. No.: 11/863,669

(22) Filed: Sep. 28, 2007

(51) Int. Cl. G06F 17/30

(52) U.S. Cl. 705/7

(57) ABSTRACT

A method for determining the value of service knowledge is provided. In one embodiment, the method includes providing a database of service knowledge, including one or more service knowledge objects, corresponding to a system. The method may also include associating the service knowledge with a plurality of taxonomic service categories associated with respective service events. Further, the method may include establishing a value of the one or more service knowledge objects. Such value may be established through a comparison of a first and second expected maintenance costs for the system determined from the service knowledge without and with, respectively, the one or more service knowledge objects. Additionally, the method may include storing or outputting the established value. Various other methods, systems, and devices are also disclosed.

### BACKGROUND

The invention relates generally to servicing of a device or system. More specifically, the present invention relates to a technique for managing and/or valuing service knowledge.

In a variety of industrial, commercial, medical, and research contexts, various pieces of equipment may be employed on a day-to-day basis to accomplish or facilitate the work being performed at a facility. In many instances, the facility may rely upon a third party to provide service for some or all of the equipment at the site to ensure that the equipment remains operational and available. For example, in an industrial setting, production equipment or computer resources that are in operation in a continuous or near-continuous manner may be serviced by an off-site party that provides servicing as needed or requested. Similarly, hospitals, clinics, and research facilities may utilize another party to service some or all of the diagnostic, monitoring, and/or imaging equipment at a site so that the equipment remains available where and when it is needed.

Such an arrangement, however, may impose burdens on the service provider that are difficult to overcome in an efficient and cost-effective manner. For example, a service provider may utilize a combination of remote personnel and field personnel to provide service to a variety of clients. In particular, remote personnel typically provide service in the form of phone support and assistance, or remote system access and diagnosis, while field personnel provide on-site support when remote support is insufficient. As one might expect, use of remote support, where possible, can provide cost and time savings for both the client and the service provider.

The magnitudes of the time, expense, and energy required to provide such services are governed, at least in part, by the resources available to the service provider and its personnel. Such resources include service knowledge collected by the service provider, and service efficiency will often depend on the quantity and the quality of such service knowledge. For instance, when considering a specific problem with a given machine, a field engineer or technician having access to service knowledge about the machine and/or the specific problem may be able to diagnose and fix the problem in only thirty minutes, whereas the same person may require several hours to diagnose and repair the problem without such service knowledge. In other cases, a sufficient level of service knowledge may allow a provider to diagnose a problem remotely, avoiding the added time and expense associated with an on-site diagnosis. Because such service knowledge may reduce the time and resources needed to provide such support, it is believed that a body of service knowledge accumulated by a service provider may often be of significant value to the service provider and its customers.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention generally relate to a technique for determining service knowledge value. In some embodiments, the technique includes providing a database of service knowledge and associating such service knowledge with a number of service categories that are, in turn, associated with one or more service events. In one exemplary embodiment, such service events may include service events requiring on-site diagnosis, service events that may entail remote diagnosis, those events that do and do not require replacement parts, pre-emptive events, proactive events, reactive events, and the like. In some embodiments, the method may include establishing a value of a service knowledge object via a comparison of an expected maintenance cost for a system in view of a body of service knowledge including the service knowledge object to the maintenance cost for the same system that would be expected if the service knowledge object were omitted from the body of service knowledge.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block-diagram of an exemplary processor-based device or system in accordance with one embodiment of the present invention;

FIG. 2 is a flow diagram of an exemplary service-knowledge management method in accordance with one embodiment of the present invention;

FIG. 3 is an exemplary service-knowledge report that may be generated in accordance with one embodiment of the present invention;

FIG. 4 is a diagram of various classifications and sub-classifications of service events that may be used in accordance with one embodiment of the present invention; and

FIG. 5 is a flow diagram of an exemplary service-knowledge valuation method in accordance with one embodiment of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

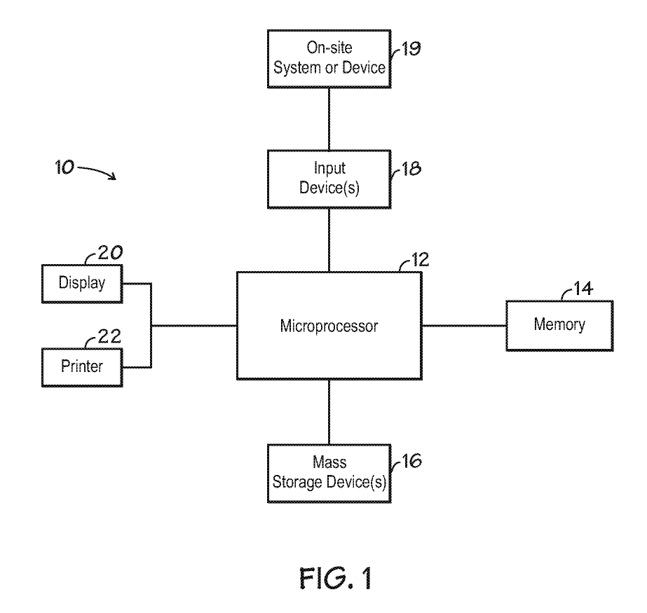

Turning now to the drawings, and referring first to FIG. 1, an exemplary processor-based system 10 for use in conjunction with the present technique is depicted. In one embodiment, the exemplary processor-based system 10 is a general-purpose computer, such as a personal computer, configured to run a variety of software, including software implementing all or part of the present technique. Alternatively, in other embodiments, the processor-based system 10 may comprise, among other things, a mainframe computer, a distributed computing system, or an application-specific computer or workstation configured to implement all or part of the present technique based on specialized software and/or hardware provided as part of the system. Further, the processor-based system 10 may include either a single processor or a plurality of processors to facilitate implementation of the presently disclosed functionality.

In general, the exemplary processor-based system 10 includes a microcontroller or microprocessor 12, such as a central processing unit (CPU), which executes various routines and processing functions of the system 10. For example, the microprocessor 12 may execute various operating system instructions as well as software routines stored in or provided by a memory 14 (such as a random access memory (RAM) of a personal computer) or one or more mass storage devices 16 (such as an internal or external hard drive, CD-ROM, DVD, or other magnetic or optical storage device). In addition, the microprocessor 12 processes data provided as inputs for various routines or software programs, such as data provided as part of the present technique in computer-based implementations.

Such data may be stored in, or provided by, the memory 14 or mass storage device 16. Alternatively, such data may be provided to the microprocessor 12 via one or more input devices 18. As will be appreciated by those of ordinary skill in the art, the input devices 18 may include manual input devices, such as a keyboard, a mouse, or the like. In addition, the input devices 18 may include a communication network or other communication interface to exchange communication of data with an on-site processor-based system or from another electronic device 19. Such a network communication interface, of course, may be bidirectional, such that the interface also facilitates transmission of data from the microprocessor 12 to a remote processor-based system or other electronic device 19 over a network.

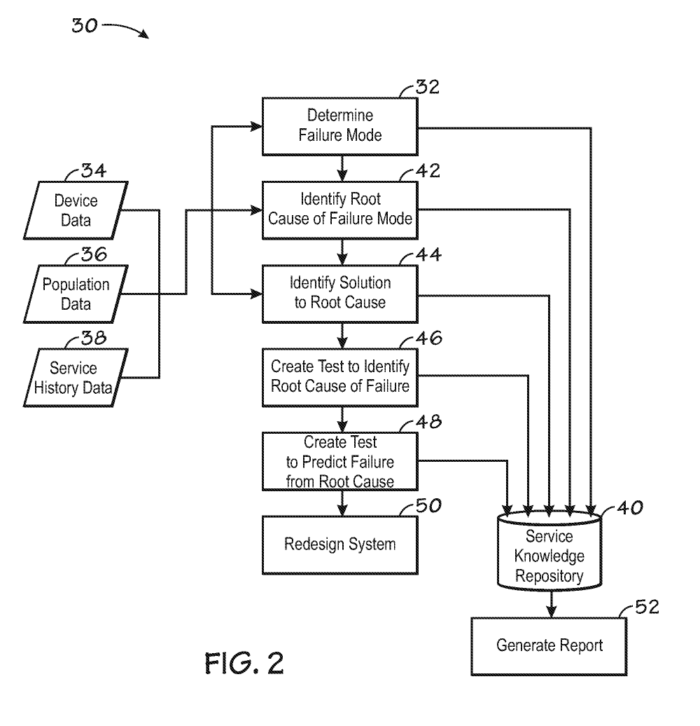

Results generated by the microprocessor 12, such as the results obtained by processing data in accordance with one or more stored routines, are provided to an operator via one or more output devices, such as a display 20 and/or a printer 22. Based on the displayed or printed output, an operator may request additional or alternative processing or provide additional or alternative data, such as via the input device 18. As will be appreciated by those of ordinary skill in the art, communication between the various components of the processor-based system 10 may typically be accomplished via a chipset and one or more busses or interconnects which electrically connect the components of the system 10. Notably, in certain embodiments of the present technique, the exemplary processor-based system 10 is configured to manage and/or estimate the value of service knowledge pertaining to one or more systems, such as medical systems, as discussed in greater detail below with respect to FIGS. 2-5.

As discussed in greater detail below, the exemplary processor based-system 10 may be configured to analyze service data and to generate a report or a “Plan of Care” for the on-site system or device 19. Certain embodiments of the on-site system or device 19 covered by the Plan of Care include a medical system (e.g., an imaging system, a diagnostic system, a monitoring system, or the like), although the on-site system or device 19 may include a non-medical system (e.g., security system, industrial system, etc.) in full accordance with the present techniques. Referring now to FIG. 2, an embodiment of steps (some or all of which may be executed by the exemplary system 10) for generating and/or updating a Plan of Care is provided. It will be appreciated that some or all of the steps may be performed as part of a software-based and/or spreadsheet-based application. In other embodiments, however, the steps may be performed via application-specific hardware or circuitry configured to perform such steps.

One embodiment of the method 30 includes a step 32 of analyzing data to calculate a trend or to predict occurrence of a failure mode at the on-site system or device 19 before actual occurrence of the failure mode. The analyzed data may include, among other things, data 34 related to the particular device or system 19 to be covered by the Plan of Care (e.g., specific temperatures, voltages, log files, and the like), data 36 pertaining to a population of other similar devices or systems (e.g., distributions of values for key parameters, anomaly trends, and average costs, among others), service history data 38 of the individual or population of similar devices or systems, or the like. For any given failure mode, a root cause of the failure mode and one or more solutions to this root cause and/or failure condition may be identified, as generally indicated in steps 42 and 44, respectively. It should be noted that the failure mode, the root cause, and the one or more solutions may be stored in a service knowledge repository or database 40. Additionally, the service knowledge repository 40 may also contain other information, such as device data 34, population data 36, service history data 38, and other data, for example. Each item of information in the service knowledge repository 40 may be considered to be a service knowledge object. Further, when an item of information stored in the service knowledge repository 40 pertains to a medical device or system, such an item may be referred to as a medical system service knowledge object.

In some embodiments, tests may be created to facilitate identification or detection of the root cause of a failure condition and/or to facilitate prediction of an increased likelihood of the failure condition directed or correlated to the root cause, as generally indicated in steps 46 and 48. Such tests may include, for example, measuring key parameters that are not directly monitored by the system, or visually inspecting mechanical parts for wear. The collected data or measurements of tests may also be added to the service knowledge repository 40. In certain cases, such as when the severity or frequency of failure of the device or system 19 due to the given root cause is sufficiently high, the device or system 19 may be redesigned, as generally indicated in step 50. The exemplary method 30 also includes a step 52 of generating a report based on data in the service knowledge repository 40, such as a Plan of Care for the device or system 19.

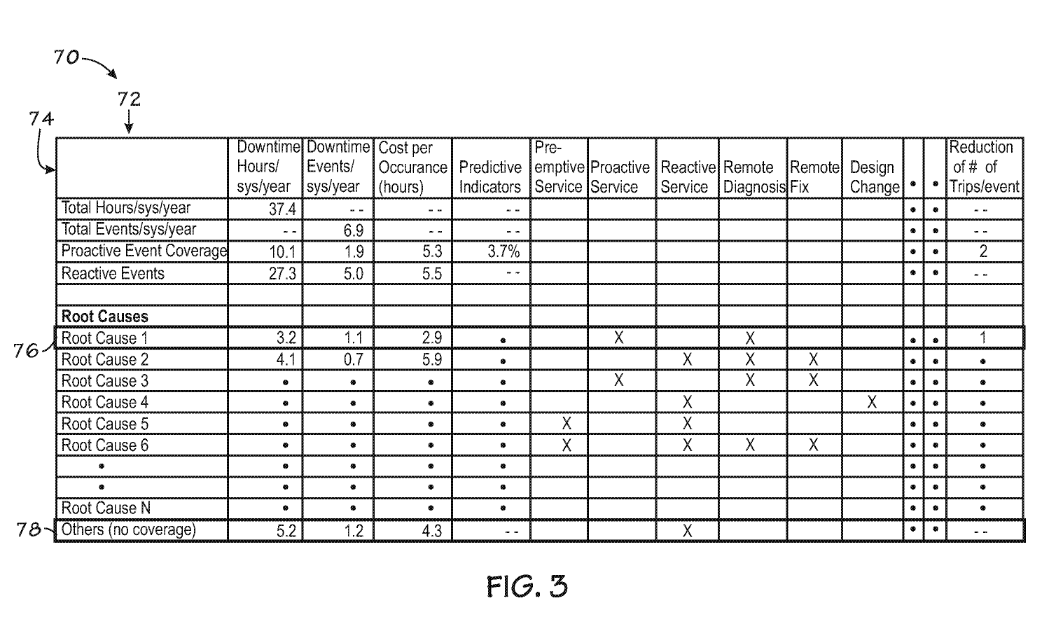

For illustrative purposes, an exemplary report or Plan of Care 70 is provided in FIG. 3 in accordance with one embodiment of the present technique. In the presently illustrated embodiment, the Plan of Care 70 is a spreadsheet including a number of rows 72 and columns 74 that contain various data relating to failure modes of the device or system 19 covered by the Plan of Care 70. Among other things, the Plan of Care 70 may include data pertaining to various root causes of failure modes of the particular device or system 19, the total expected downtime hours and events each year attributable to failure conditions, and the portion of such downtime events that are addressed and/or remedied preventatively (e.g., maintenance before occurrence of a failure condition, such as utilizing the signature analysis of a drive gear in a CT gantry to detect an anomaly (a cracked tooth or worn bearing, for example), which can be corrected before it fails), relative to or versus reactively (e.g., after a failure condition has occurred).

For purposes of explanation, it may be useful to refer to exemplary rows 76 and 78 of the Plan of Care 70. Referring first to row 76, data pertaining to a known root cause (“Root Cause 1”) is provided. In this exemplary embodiment, the data includes frequency data (e.g., downtime events for each system per year) and severity data (e.g., the cost and/or downtime associated with each event), which may be used to provide an estimated total of downtime hours for each system per year. As depicted in FIG. 3, the Plan of Care 70 may include such data broken down by each known root cause, such as Root Cause 1 in row 76, and unknown root causes, as provided in row 78.

For the known root causes (e.g., Root Cause 1-Root Cause N), indicators may be developed and/or provided to facilitate prediction of a future occurrence of a failure mode or condition attributable to a known root cause, as noted above. For example, flow rate sensors may be added to existing temperature sensors to better characterize the operation of a cooling system. The existence of such a predictive indicator may be noted in the Plan of Care 70. Additionally, for those root causes associated with such predictive indicators, various performance metrics of the indicator may also be provided in the Plan of Care 70, such as data indicative of the sensitivity and/or specificity of the predictive indicator. The exemplary Plan of Care 70 also includes columns that indicate whether a root cause may be addressed through pre-emptive, proactive or reactive servicing, along with indications of any root causes that may be remotely diagnosed and/or remotely remedied. The Plan of Care 70 may also indicate that a design change may be desirable to reduce or eliminate a particular failure mode attributable to a known root cause. It will, of course, be appreciated that the data of FIG. 3 is provided for purposes of explanation, and that other reports or Plans of Care 70 may include some or all of this data, as well as additional data that is not provided in FIG. 3, in full accordance with the present techniques.

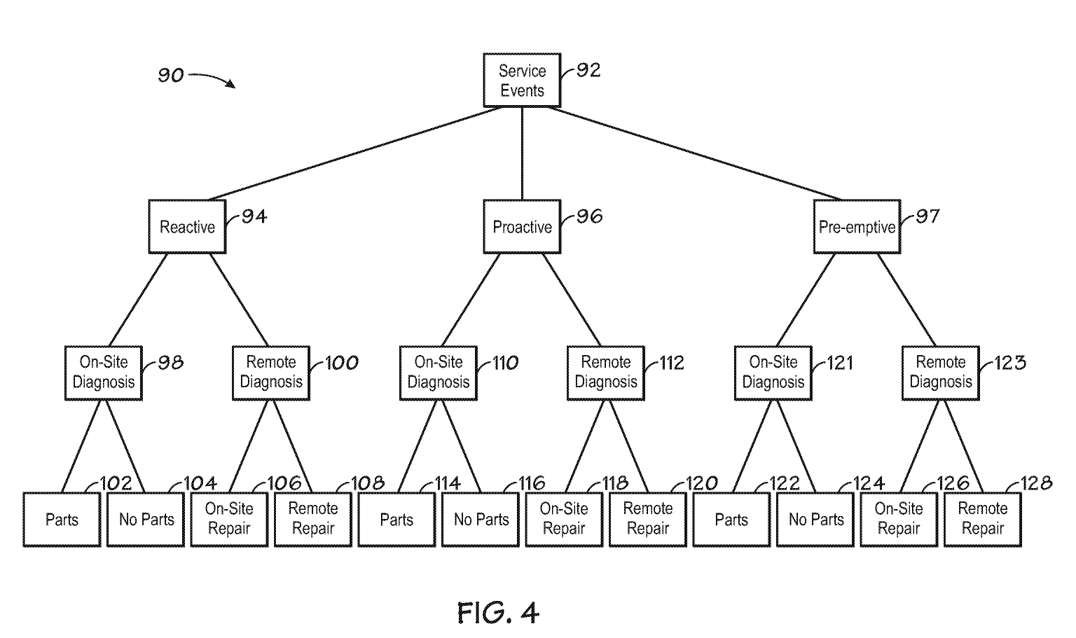

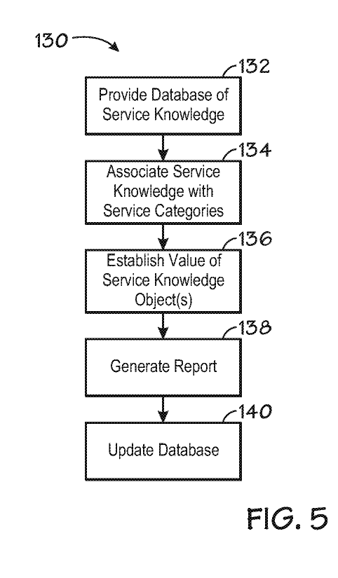

In certain embodiments, the exemplary system 10 is also configured to analyze service data to determine, or estimate, the business value of the service knowledge, as discussed in greater detail below with respect to FIGS. 4 and 5. In one embodiment, the system 10 is configured to trigger service of a given device or system 19 in response to the tracking or detecting of multiple types of service events. Service events or actions may be divided into taxonomic service categories, as generally represented by diagram 90 in FIG. 4. For instance, service events 92 may be considered to be either reactive events 94 or preventative events, such as proactive events 96 and pre-emptive events 97. Reactive events 94 generally follow the occurrence or detection of a failure condition. Preventative events 96 generally include servicing performed “before” a failure condition occurs, such that service occurs on systems or devices 19 which do not yet exhibit a failure condition. It should be noted that, in some embodiments, such preventative service events may occur in response to one or more detected or tracked events or data, as discussed in greater detail below.

The reactive events 94 may be subdivided into events 98 in which failure conditions are diagnosed and remedied on-site (i.e., on the same premises as the device or system 19), and events 100 in which failure conditions may be detected remotely (i.e., off-site) from the system or device 19. For events detected on-site, repair of the on-site system or device 19 may or may not require replacement parts (blocks 102 and 104). Remote events 100 can be further subdivided into events 106 in which the repair may occur on-site generally at the on-site system or device 19, and events 108 in which repair of the on-site system or device 19 may occur remotely, such as via the microprocessor 12 of the system 10. On-site service events 106 may also be further subdivided into those that require replacement of parts and those that do not.

Types of preventative service events include proactive service events 96 and pre-emptive service events 97. Proactive service events 96 are generally triggered in response to a request generated at the system 10 (e.g., based upon elapsed time, number of scanner rotations, number of patients, or the like). Pre-emptive service events 97 are generally triggered by a time, a system usage, or a system condition (e.g., calculated trend in power or current consumption, error in recognition of an address, lack of detection of a diagnostic output, detection of a fall below a predetermined cryogenic level, etc.) to mitigate the likelihood of occurrence of a system failure condition that may or may not cause undesired interruption or down-time of the device or system 19. Pre-emptive service events 97 can also generally be triggered in response to detection or identification of a pre-failure system state or trend so as to reduce a likelihood of occurrence of the failure condition. An example of pre-emptive service event is an encoder error that occurs before an occurrence of a fault condition at the device or system 19. The microprocessor 12 can receive a signal representative of the detection of the encoder error, verify the error, and send a request to service, which may or may not include on-site replacement of parts, before occurrence of the fault condition at the device or system 19. The microprocessor 12 may also create a display of the detection of the error in a report to the service provider and/or customer for review that includes an identification reference and the respective pre-emptive event, the calculated diagnosis of the respective fault condition of increased likelihood of occurrence correlated to the pre-emptive event, and the known service triggered to prevent or at least reduce the increased likelihood of the fault condition. As another example, the microprocessor 12 may receive a signal representative of the pre-emptive event where not all of the addresses of a number of drives are detected upon boot-up of the device or system 19. In such an embodiment, the microprocessor 12 may calculate or identify a response to the pre-emptive event (e.g., with or without on-site replacement of a software module or part), and communicate the request to trigger service to prevent or at least reduce the likelihood of the occurrence of the predicted fault condition at the device or system 19 correlated to the detected pre-emptive event.

The proactive and pre-emptive service events 96 and 97 each may be divided into those in which failure conditions are diagnosed and remedied on-site (block 110 and 121) and those in which failure conditions may be diagnosed remotely (block 112 and 123) at the microcontroller 12 of the system 10. Likewise, events 110 and 121 may be divided into categories according to whether or not a repair will require replacement of parts (blocks 114 and 116, 122 and 124, respectively), and remotely-diagnosed events 112 and 123 may be divided into categories indicative of on-site repair or remote repair (blocks 118 and 120, 126 and 128, respectively). Further, events 118 and 126 may also be subdivided into those that do and those that do not require replacement parts for the device or system. It will be appreciated that the foregoing discussion of service event categories is not exhaustive, and that other categories may be used in addition to, or in place of, those explicitly discussed above in accordance with the present techniques.

In some embodiments, a technical effect of the Plan of Care or report 70 that triggers service or maintenance in response to detection of proactive or preemptive events 96 and 97, in comparison to maintenance triggered in response to reactive service events, is the reduction of undesired disruption which may be caused by downtime of the on-site device or system 19 caused by the failure condition. The system 10 may also allow diagnosis or repair of the device or system 19 remotely rather than on-site. In one embodiment, the system 10 also reduces the number of service events requiring replacement parts in favor of those that do not require replacement parts, such as to reduce the inventory that a service provider or technician must maintain to service the on-site device or system 19. Also, the system 10 may reduce the total number of the service events of the on-site device or system 19. Additionally, assuming that each of these service categories has known and/or estimated costs, the system 10 may allow calculation of a value to moving events from one category to another (e.g., from reactive to proactive or pre-emptive, from on-site diagnosis to remote diagnosis, and so forth), as discussed below.

In some embodiments, a Plan of Care 70 includes sufficient data to categorize service events associated with a known or unknown root cause with service categories, such as those discussed above with respect to FIG. 4. As service knowledge about a given system covered by the Plan of Care 70 changes, the data contained therein may be updated and the number of service events associated with each of the service categories may change. For example, developing/implementing an algorithm that can effectively characterize the degradation of a bearing through noise and/or current measurements would move this failure mode from reactive to predictive. Consequently, for a given device or system 19, the relative weights of each service category may change as the Plan of Care 70 for the device or system 19 changes.

Along these lines, service knowledge objects (e.g., identification of root causes, development of repair solutions, development of predictive or identification tests, and the like) may be provided, as discussed above with respect to FIG. 2, to facilitate updating of the Plan of Care 70. For example, service personnel may identify a new root cause for a failure mode, which may be added to the service knowledge repository 40. Accordingly, an updated Plan of Care 70 may include an additional row indicative of this newly-discovered root cause, and the addition of the new root cause may reduce the frequency of failure conditions attributable to unknown root causes (e.g., row 78 of the exemplary Plan of Care 70). When a solution or fix is identified and entered into the service knowledge repository 40, it may reduce the cost associated with addressing that failure condition. Given the new root cause, a test for identifying the root cause may be developed, further reducing the cost associated with addressing the root cause. For instance, a new test or diagnostic procedure may be added to further isolate an amplifier fault in the field, thus enabling the replacement of a sub-component in lieu of the entire module. Of course, tests may also be developed for identifying previously-known root causes. Further, a test may also be provided to predict a failure condition based on a particular root cause, generally allowing a service event associated with the root cause to be changed from a reactive service event 94 to a proactive service event 96 or pre-emptive service event 97. In some cases, a new test or technique may enable a particular root cause to be diagnosed and/or fixed remotely.

As noted above, changes to the Plan of Care 70 for given on-site device or system 19, such as through the addition of a new root cause or some other service knowledge object to the service knowledge repository 40, may change the relative weights or the number of events 94, 96, and/or 97 associated with service categories, such as those discussed above with respect to FIG. 4. Based on the different costs associated with each of these service event categories (e.g., events 94, 96, and/or 97), changes to the Plan of Care 70 and to the relative weights of the service categories may be used to calculate the value of a particular service knowledge object, such as through the exemplary method 130 of FIG. 5.

In one embodiment, the exemplary method 130 includes providing a database, such as the service knowledge repository 40, containing one or more service knowledge objects for the on-site system 19, as generally indicated at step 132. The method 130 also includes a step 134 of associating the service knowledge objects with various service categories, such as those discussed above. Further, the method 130 includes a step 136 for establishing the value of one or more service knowledge objects. For instance, in one embodiment, step 136 includes determining expected costs, such as maintenance costs (which may include, among other things, customer costs, vendor costs, and/or opportunity costs associated with such maintenance), for the on-site device or system 19 covered by the Plan of Care 70 based at least in part on the service knowledge stored in the service knowledge repository 40, exclusive of the one or more service knowledge objects to be valued, and/or on the relative weight of the service categories (e.g., through a weighted-average, such as an event-frequency weighted average, of the service categories). This first cost may then be compared with a second expected cost for the system or device 19 that is determined based at least in part on the service knowledge of service knowledge repository 40, inclusive of the one or more service knowledge objects being valued, and/or on the updated relative weights of the service categories to determine the value of the one or more service objects. In certain embodiments, this process enables a user to determine the value of a single service knowledge object and/or of a group of such objects. Once the value of these one or more service knowledge objects is determined through step 136, the result may be stored and/or output, such as via the generation of a report, as generally indicated in step 138. The database may also be updated based on such information, as provided in step 140.

It should also be noted that planning decisions for developing new service knowledge objects (e.g., identification of root causes, development of repair solutions, development of predictive or identification tests, and the like) may be made through a cost-effectiveness analysis. As may be appreciated, such an analysis may allow for a wide array of decision constraints, which may or may not be weighted according to relative importance. Additionally, the Plan of Care 70 discussed above may be used in such an analysis, or in other analyses, such as a failure mode, effects, and criticality analysis (FMECA).

Still further, a Plan of Care 70 may be used to monitor service delivery for one or more of the covered devices, machines, or systems 19. For instance, field measurements by service personnel may be used to update various data in the Plan of Care 70, such as the frequency and/or the severity data. Also, such data may be weighted by relative importance to provide a 'service outcome” measurement to facilitate measurement and comparison of service delivery outcomes for given devices or systems 19 over time, across different model types, or the like.

While only certain features of the subject matter have been illustrated and described herein, many modifications and changes will occur to those skilled in the art. It is, therefore, to be understood that the appended claims are intended to cover all such modifications and changes as fall within the true spirit of the subject matter described herein.

1. A method to determine a value of service knowledge, the method comprising:
providing a database of service knowledge corresponding to a system, the service knowledge including at least one service knowledge object;
associating the service knowledge with a plurality of taxonomic service categories, wherein each of the taxonomic service categories is associated with at least one respective service event;
establishing a value of the at least one service knowledge object, wherein establishing the value includes comparing a first expected maintenance cost for the system, determined at least in part from the service knowledge exclusive of the at least one service knowledge object, with a second expected maintenance cost for the system, determined at least in part from the service knowledge inclusive of the at least one service knowledge object; and
storing and/or outputting the established value.

2. The method of claim 1, wherein the at least one service knowledge object is a medical system service knowledge object.

3. The method of claim 1, wherein the plurality of taxonomic service categories comprises a reactive events category and a preventative events category.

4. The method of claim 3, wherein the preventative events category comprises a proactive events category and/or a pre-emptive events category.

5. The method of claim 3, wherein the reactive and preventative events categories are associated with respective estimated event costs, and the first and second expected maintenance costs are determined from a weighted average of the respective estimated costs of the reactive and preventative events.

6. The method of claim 5, wherein the inclusion of the at least one service knowledge object in the service knowledge reduces the respective estimated costs of the reactive and/or preventative events category.

7. The method of claim 5, wherein the weighted average comprises an event-frequency weighted average.

8. The method of claim 7, wherein the inclusion of the at least one service knowledge object in the service knowledge changes the relative frequency of events associated with the reactive and/or preventative events category.

9. The method of claim 1, wherein the plurality of taxonomic service categories comprise an on-site diagnosis category and a remote diagnosis service category.

10. The method of claim 9, wherein the remote diagnosis service category comprises an on-site repair category and a remote repair category.

11. The method of claim 1, wherein known event service costs are associated with at least two categories of the plurality of taxonomic service categories.

12. The method of claim 11, wherein the first and second expected maintenance costs are determined via an event-frequency weighted average of the known event service costs.

13. The method of claim 12, wherein the inclusion of the at least one service knowledge object in the service knowledge modifies the frequency of events associated with one or more of the categories of the plurality of taxonomic service categories.

14. The method of claim 12, wherein the value of the at least one service knowledge object is the difference between the first and second expected maintenance costs.

15. The method of claim 1, wherein the first and second expected maintenance costs include opportunity costs associated with downtime of the system.

16. The method of claim 1, comprising updating the database of service knowledge by adding an additional service knowledge object to the database.

17. The method of claim 1, wherein the service knowledge object comprises at least one of a root cause of a failure condition, a fix for the root cause, or a test for identifying the root cause.

18. A system for determining service knowledge value, the system comprising:
one or more memory devices having service knowledge for a machine and a plurality of routines stored therein, the service knowledge comprising a plurality of individual service knowledge objects; and
one or more processors configured to execute the plurality of routines stored in the memory device, the plurality of routines comprising:
a routine for determining a first expected cost for maintaining the machine based at least in part on the plurality of individual service knowledge objects;
a routine for determining a second expected cost for maintaining the machine based at least in part on the plurality of individual service knowledge objects and an additional individual service knowledge object;
a routine for determining a value of the additional individual service knowledge object via comparison of the first and second expected costs; and
a routine for outputting and/or storing the value of the additional service knowledge object.

19. The system of claim 18, wherein the plurality of routines comprises a routine for updating the service knowledge.

20. The system of claim 18, wherein the plurality of service knowledge objects comprises one or more root causes of one or more failure conditions of the machine.

21. The system of claim 20, wherein the plurality of service knowledge objects comprises one or more repair solutions for the one or more root causes.

22. One or more computer-readable media having application instructions for determining service knowledge value encoded thereon, the application instructions comprising:
instructions adapted to determine a first expected cost for maintaining a machine based at least in part on a plurality of individual service knowledge objects pertaining to the machine;
instructions adapted to determine a second expected cost for maintaining the machine based at least in part on the plurality of individual service knowledge objects and an additional individual service knowledge object pertaining to the machine;
instructions adapted to determine a value of the additional individual service knowledge object via comparison of the first and second expected costs; and
instructions adapted to output and/or store the value of the additional service knowledge object.

23. The one or more computer readable media of claim 22, wherein the application instructions comprise instructions adapted to facilitate user entry of additional service knowledge to a database having the plurality of individual service knowledge objects stored therein.
